(19) United States
(12) Patent Application Publication
(10) Pub. No.: US 2008/0150439 A1
(43) Pub. Date: Jun. 26, 2008

(54) Serial powering of an light emitting diode string

(75) Inventor: Constantin Bucur, Sunnyvale, CA (US)

Correspondence Address: PATENT PROSECUTION;O2MIRCO , INC., 3118 PATRICK HENRY DRIVE, SANTA CLARA, CA, 95054, US

(73) Assignee: O2Micro. Inc.

(21) Appl. No.: 12/074,301

(22) Filed: Mar. 3, 2008

Related U.S. Application Data
(63) Continuation-in-part of application No. 11/282,097, filed on Nov. 16, 2005, now Pat. No. 7,339,323.
(60) Provisional application No. 60/676,448, filed on Apr. 29, 2005.

(51) Int. Cl. H05B 37/00

(52) U.S. Cl. 315/186

(57) ABSTRACT

A circuit for driving multiple light emitting diodes coupled in series includes multiple switches for receiving multiple burst mode modulation signals respectively. Each switch is coupled in parallel with a corresponding light emitting diode and for individually controlling brightness of the corresponding light emitting diode. The circuit further includes a control switch coupled in series with multiple light emitting diodes and for controlling brightness of multiple light emitting diodes. The control switch is either on or off. One of the burst mode modulation signals has a duty cycle ratio for modulating a current through the corresponding light emitting diode from 0 to a predetermined value.

### RELATED APPLICATIONS

This application is a continuation-in-part of the co-pending U.S. application Ser. No. 11/282,097, entitled “Serial Powering of an LED String”, filed on Nov. 16, 2005, which itself claims priority to the co-pending provisional patent application Ser. No. 60/676,448, entitled “Serial Powering of an LED String”, filed on Apr. 29, 2005, which is herein incorporated by reference in its entirety.

### TECHNICAL FIELD

This invention relates to a circuit for driving or powering loads, and more particularly to a circuit or a method for driving or powering light emitting diodes (LEDs) which are coupled in series.

### BACKGROUND ART

Referring to FIG. 1, a typical circuit 10 for driving or powering a plurality of LEDs in the prior art is illustrated. For example, the circuit 10 is used for driving four LEDs 22, 24, 26, and 28, as shown in FIG. 1. It will be appreciated that the LEDs 22, 24, 26, and 28 are coupled in parallel. An external voltage source is coupled to a driver 12 for supplying a voltage Vcc to the driver 12. The driver 12 has a low-dropout (LDO) regulator 14 for supplying a regulated voltage Vreg to the LEDs 22, 24, 26, and 28. Typically, the regulated voltage Vreg can be 3.3 volts. The LEDs 22, 24, 26, and 28 are coupled to switches 32, 34, 36 and 38 and resistors 42, 44, 46, and 48, respectively. As shown in FIG. 1, the LEDs 22, 24, 26, and 28, the switches 32, 34, 36 and 38, and the resistors 42, 44, 46, and 48 are coupled in series, respectively.

For example, the current requirement for each LED of the LEDs 22, 24, 26, and 28 is 10 mA. If the voltage Vcc of the external voltage source is 30 V, the power requirement Pw for the LEDs 22, 24, 26, and 28 can be calculated as follows: Pw=30V×4×10 mA=1.2 W.

In practice applications, the circuit 10 may be installed in a portable device, such as a cellular phone, a digital camera, a laptop computer, an electrical vehicle or a portable power tool. However, the circuit 10 may dissipate a significant amount of power. This can be a critical issue from some points of view, such as IC design, system power budget, and power dissipation inside the system.

### SUMMARY

In one embodiment, a circuit for driving multiple light emitting diodes coupled in series includes multiple switches for receiving multiple burst mode modulation signals respectively. Each switch is coupled in parallel with a corresponding light emitting diode and for individually controlling brightness of the corresponding light emitting diode. The circuit further includes a control switch coupled in series with multiple light emitting diodes and for controlling brightness of multiple light emitting diodes. The control switch is either on or off, in one embodiment. One of the burst mode modulation signals has a duty cycle ratio for modulating a current through the corresponding light emitting diode from 0 to a predetermined value.

### BRIEF DESCRIPTION OF THE DRAWINGS

Other objects, advantages, and novel features of the invention will become more apparent from the following detailed description when taken in conjunction with the accompanying drawings.

FIG. 1 is a block diagram showing a circuit for driving a plurality of LEDs in the prior art.

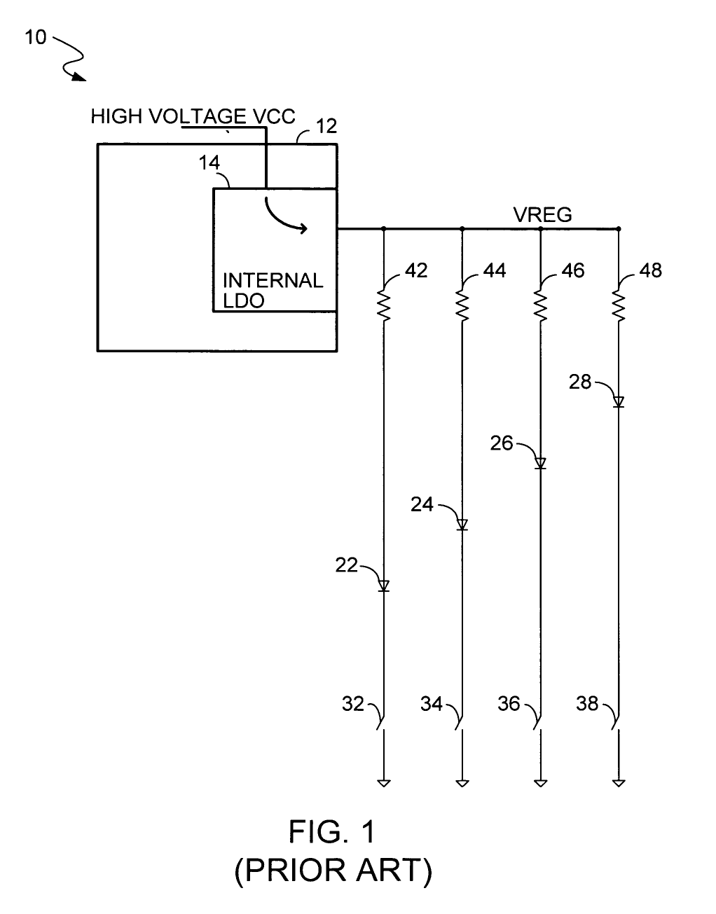

FIG. 2 is a block diagram showing a circuit for driving a plurality of LEDs according to one embodiment of the present invention.

FIG. 3 shows some exemplary waveforms of the burst mode modulation signals according to one embodiment of the present invention.

FIG. 4 is a diagram showing a method for driving a plurality of LEDs according to embodiments of the present invention.

### DETAILED DESCRIPTION

Reference will now be made in detail to the embodiments of the present invention, serial powering of an light emitting diode string. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

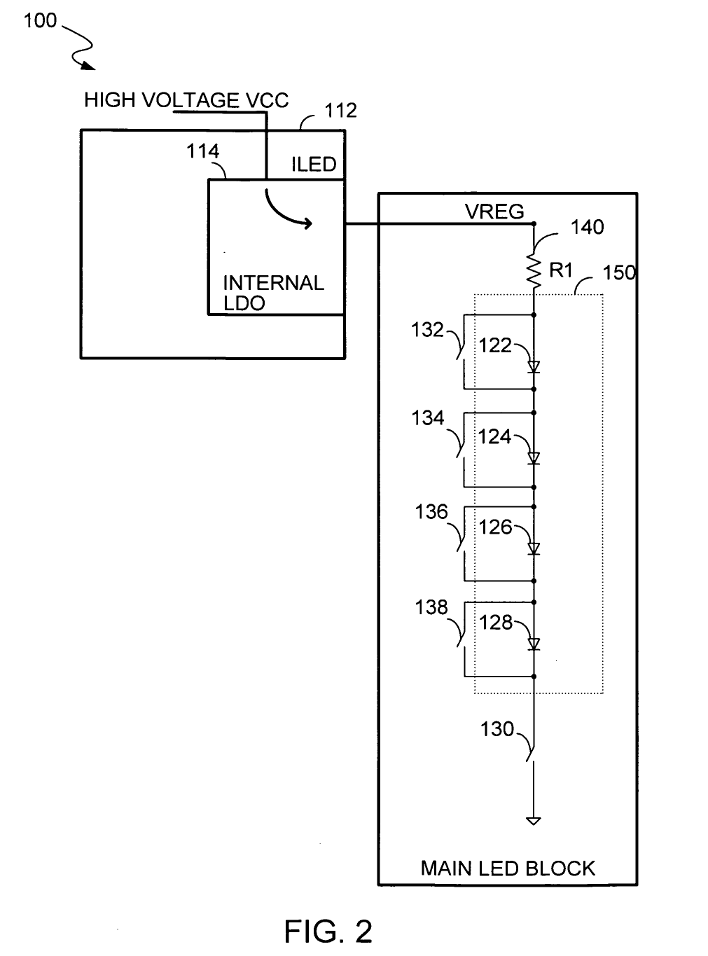

Referring to FIG. 2, a circuit 100 for driving or powering a plurality of loads, such as LEDs, according to an embodiment of the present invention is illustrated. For example, as illustrated in FIG. 2, the circuit 100 is used for driving four LEDs 122, 124, 126, and 128. Other embodiments are well suited to supporting any number of LEDs. In addition, other embodiments of the present invention can support the use of other types of loads in place of the LEDs 122, 124, 126, and 128.

As shown in FIG. 2, the LEDs 122, 124, 126, and 128 are coupled with each other in series so as to form a string 150. An external voltage source is coupled to a driver 112 for supplying a voltage Vcc to the driver 112. The driver 112 has a linear regulator, such as a voltage follower, a shunt regulator or a low-dropout (LDO) regulator 114, for supplying a regulated voltage Vreg to the LEDs 122, 124, 126, and 128. In one embodiment, the voltage Vcc is higher than the regulated voltage Vreg. In an alternate embodiment, the external voltage source may not need to be regulated such that the Vcc can directly power the LED string 150.

The LEDs 122, 124, 126, and 128 coupled in series are also coupled to a resistor 140 and a control switch 130. A plurality of switches 132, 134, 136, and 138 are coupled to the LEDs 122, 124, 126, and 128 in parallel, respectively. That is, each switch of the plurality of switches 132, 134, 136, and 138 is coupled in parallel with a corresponding LED. For instance, switch 132 is coupled in parallel with the LED 122. In this arrangement, the regulated voltage Vreg from the LDO regulator 114 of the driver 112 is supplied to the resistor 140 and the LEDs 122, 124, 126, and 128, such that all the LEDs 122, 124, 126, and 128 can be powered on, in one embodiment.

Advantageously, the switches 132, 134, 136, and 138 coupled to the LEDs 122, 124, 126, and 128 are able to control the brightness of the individual LEDs 122, 124, 126, and 128. The switches 132, 134, 136, and 138 serve as bypass current paths for the LEDs 122, 124, 126, and 128. For example, the switch 132 serves as a bypass current path for the LED 122, the switch 134 serves as a bypass current path for the LED 124, the switch 136 serves as a bypass current path for the LED 126, and the switch 138 serves as a bypass current path for the LED 128.

In one embodiment, each switch of the switches 132, 134, 136, and 138 is either fully turned on or fully turned off. A corresponding LED will be turned off when a corresponding switch is off, in one embodiment. The corresponding LED will be turned on when the corresponding switch is on. For example, the LED 122 will be turned off when the switch 132 is off and the LED 122 will be turned on when the switch 132 is on. Similarly, the LEDs 124, 126, and 128 can be turned on and off through the switches 134, 136, and 138, respectively.

Furthermore, a pulse width modulation (PWM) controlled method is incorporated, in accordance with one embodiment of the present invention. The PWM signals can be used to control the switches 132, 134, 136, and 138 in order to individually control the brightness of the LEDs 122, 124, 126, and 128. For example, taking the LED 122 for example, a controller (not shown in FIG. 2) can be used to generate a PWM signal to enable or disable the switch 132 so as to control the brightness of the LED 122 or dim the LED 122. More specifically, when any one of the LEDs 122, 124, 126, and 128 is shorted or is turned off, the brightness of the rest thereof can be varied. Advantageously, the PWM signals can be used to control the switches for the rest of the LEDs so as to prevent the brightness from varying. In addition, when the LEDs 122, 124, 126, and 128 emit different colors, the switches 132, 134, 136, and 138 also can be used to eliminate the brightness difference of the LEDs 122, 124, 126, and 128 by controlling duty cycles of the PWM signals.

According to one embodiment of the present invention, the current through each of the LEDs 122, 124, 126, and 128 can be diverted by the switches 132, 134, 136, and 138. The diverted current through each switch can range from 0 to a predetermined level. In one embodiment, the predetermined level can be a maximum current Id_max, as shown in equation 1:

Id_max=Vled/Ronsw (1)

In equation (1), Vled represents a nominal voltage of each LED of the LEDs 122, 124, 126, and 12, and Ronsw represents a resistance of each LED of the switches 132, 134, 136, and 138 on the condition that the current through the resistor 140 is less than [Vreg−NxVled]/R1, which will be described hereinafter in detail.

In this case, the current is diverted by a factor proportional to the duty cycle ratio of the PWM signal applied to the corresponding switch, in accordance with one embodiment of the present invention. For purposes of illustration, taking the LED 122 as an example, assume that the current through the resister 140 is lex, the voltage of the LED 122 is V122, and the resistance of the switch 132 is R132. Therefore, the current through the switch 132 is varied from 0 to Id_max=V122/R132, and the current through the LED 122 is varied from lex to lex−(V122/R132). If (V122/R132) is greater than or equal to lex, the current through the LED 122 is varied from lex to 0, in one embodiment.

Similarly, the current through the LEDs 124, 126, and 128 can be respectively modulated by the switches 134, 136, and 138 from lex to 0 according to the PWM signals. Accordingly, the current through each individual LED can be adjusted, regardless how many LEDs are turned on at a given time, in one embodiment.

Furthermore, in one embodiment, when all the LEDs 122, 124, 126, and 128 need to be turned on, an initial current Icc_max is required, as shown in equation (2):

Icc_max=[Vreg−NxVled]/R1 (2)

In equation (2), NxVled represents a summation of the voltages of the LEDs 122, 124, 126, and 128, and R1 represents a resistance of the resistor 140.

The initial current, Icc_max is less than the maximum continuous current which is the maximum allowed current through the LEDs 122, 124, 126, and 128, in one embodiment.

Furthermore, the control switch 130 can be used to turn off all of the LEDs 122, 124, 126, and 128. Also, the control switch 130 can be used for controlling or dimming the entire LED string 150 of the LEDs 122, 124, 126, and 128.

The circuit 100 according to one embodiment of the present invention is able to power or drive a plurality of LEDs (e.g., LEDs 122, 124, 126, and 128), and also to reduce/adjust the current through each individual LED by controlling a corresponding switch in parallel with each individual LED. As a result, the circuit 100 according to one embodiment of the present invention is able to reduce the power dissipation.

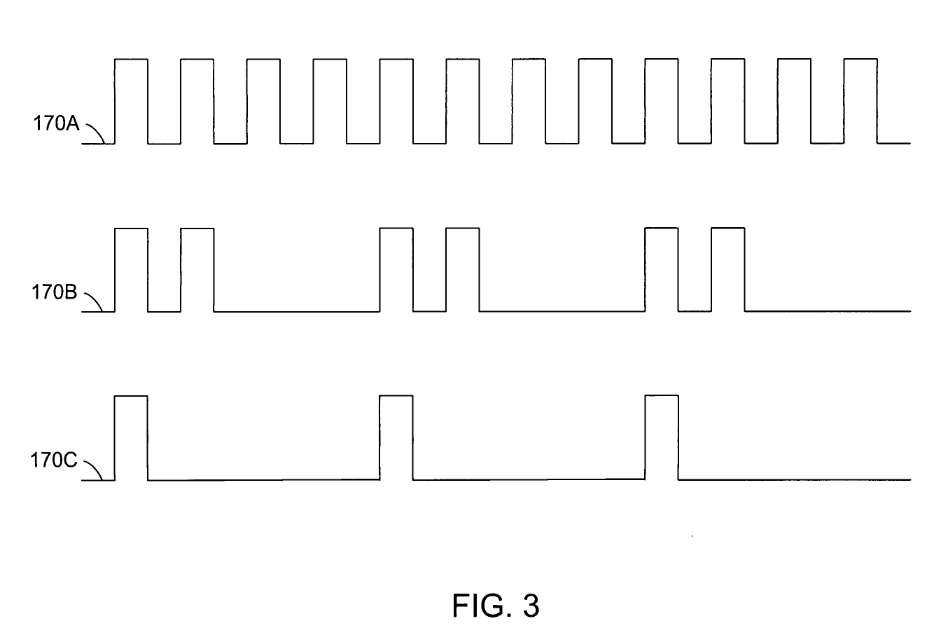

In one embodiment, the plurality of switches 132, 134, 136, and 138 can also be controlled by burst mode modulation signals (or spread spectrum signals) instead of PWM signals. FIG. 3 shows some exemplary waveforms 170A, 170B, and 170C for the burst mode modulation signals according to one embodiment of the present invention. For example, waveform 170A shows a burst mode modulation signal with a duty cycle of 100%. Waveform 170B shows a burst mode modulation signal with a duty cycle of 50%. Waveform 170C shows a burst mode modulation signal with a duty cycle of 25%. The duty cycle of the burst mode modulation signal depends on the number of pulses during one period. Similarly, the current through each the LED 122, 124, 126, and 128 can be respectively modulated by the switches 132, 134, 136, and 138 from lex to 0 according to the burst mode modulation signals.

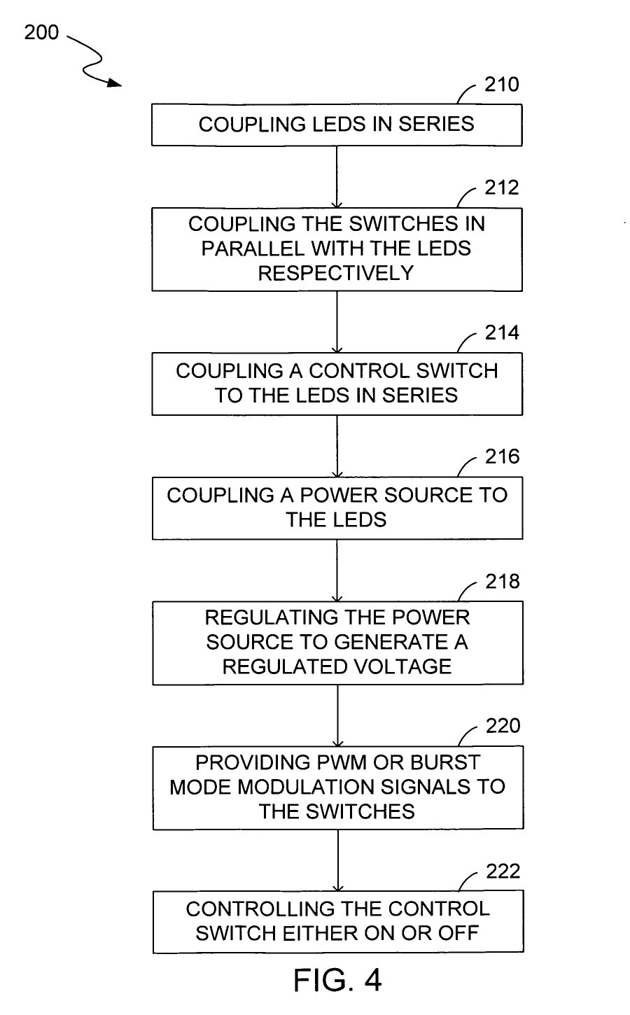

Referring to FIG. 4, a method 200 for driving light emitting diodes according to embodiments of the present invention is illustrated. FIG. 4 is described in combination with FIG. 2. At 210, a plurality of LEDs 122, 124, 126, and 128 are coupled in series. At 212, a plurality of switches 132, 134, 136, and 138 are coupled to LEDs 122, 124, 126, and 128 in parallel, respectively. That is, each LED 122, 124, 126, and 128 is coupled in parallel to a corresponding switch 132, 134, 136, and 138. At 214, a control switch 130 is coupled to plurality of LEDs 122, 124, 126, and 128 in series. This control switch 130 controls power to the plurality of LEDs 122, 124, 126, and 128. At 216, a power source is coupled to one end of the plurality of LEDs 122, 124, 126, and 128 to deliver power to the plurality of LEDs 122, 124, 126, and 128. At 218, the power source is regulated to generate a regulated voltage. The regulated voltage is provided to one end of the LEDs for supplying power to the LEDs 122, 124, 126, and 128. At 220, a plurality of pulse width modulation (PWM) signals or a plurality of burst mode modulation signals are respectively provided to the plurality of switches 132, 134, 136, and 138 for individually controlling the brightness of each LED of the plurality of LEDs 122, 124, 126, and 128. At 222, the entire brightness of the plurality of LEDs 122, 124, 126, and 128 is controlled by means of controlling the control switch 130 either on or off. For example, when the switch is engaged (on) power is delivered to the plurality of LEDs. Also, when the switch is disengaged (off), power is not delivered to the plurality of LEDs. As a result, a current through each LED of the plurality of LEDs 122, 124, 126, and 128 can be modulated from 0 to a predetermined value.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. For example, different type of loads can be used in place of the LEDs, or the PWM generation can be analog or digital. The presently disclosed embodiments are therefore to be considered in all respects as illustrative and not restrictive, the scope of the invention being indicated by the appended claims and their legal equivalents, and not limited to the foregoing description.

What is claimed is:

1. A circuit for driving a plurality of light emitting diodes coupled in series, comprising:
a plurality of switches for receiving a plurality of burst mode modulation signals, each switch of said plurality of switch is coupled in parallel with a corresponding light emitting diode in said plurality of light emitting diodes and for individually controlling brightness of said corresponding light emitting diode; and
a control switch coupled in series with said plurality of light emitting diodes and for controlling brightness of said plurality of light emitting diodes, said control switch is either on or off,
wherein one of said plurality of burst mode modulation signals has a duty cycle ratio for modulating a current through said corresponding light emitting diode from zero to a predetermined value.

2. The circuit as claimed in claim 1, further comprising:
a voltage source coupled to one end of said plurality of light emitting diodes and for powering said plurality of light emitting diodes;

3. The circuit as claimed in claim 2, further comprising:
a low-dropout regulator coupled to said voltage source and for providing a regulated power to said plurality of light emitting diodes.

4. The circuit as claimed in claim 1, further comprising:
a resistor coupled to said plurality of light emitting diodes in series.

5. A method for driving a plurality of light emitting diodes, comprising:
coupling said plurality of light emitting diodes in series;
coupling each switch of a plurality of switches in parallel with a corresponding light emitting diode in said plurality of light emitting diodes for individually controlling brightness of said corresponding light emitting diode;
controlling each switch by a burst mode modulation signal, thereby controlling power delivered to said corresponding light emitting diode;
switching a control switch that is coupled to said plurality of light emitting diodes in series either on or off for controlling brightness of said plurality of light emitting diodes; and
modulating a current through each light emitting diode of said plurality of light emitting diodes from 0 to a predetermined value.

6. The method as claimed in claim 4, further comprising:
coupling a power source to one end of said plurality of light emitting diodes;
regulating said power source to generate a regulated voltage for powering said plurality of light emitting diodes.

7. The method as claimed in claim 4, further comprising:
turning on said control switch to turn on said plurality of light emitting diodes; and
turning off said control switch to turn off said plurality of light emitting diodes.

8. The method as claimed in claim 4, further comprising:
modulating said current according to a duty cycle of said burst mode modulation signal.
